(19) United States
(12) Patent Application Publication
(10) Pub. No.: US 2008/0006184 A1
(43) Pub. Date: Jan. 10, 2008

(54) Hitch receiver table

(76) Inventor: Doug Simon, Columbia, MO (US)

Correspondence Address: BRYAN CAVE LLP, 211 NORTH BROADWAY, SUITE 3600, ST. LOUIS, MO, 63102-2750, US

(21) Appl. No.: 11/796,053

(22) Filed: Apr. 26, 2007

Related U.S. Application Data
(60) Provisional application No. 60/795,380, filed on Apr. 27, 2006.

(51) Int. Cl. B60R 9/06; A47B 5/00

(52) U.S. Cl. 108/44; 224/521

(57) ABSTRACT

The present invention relates to vehicle hitch receiver accessories. More particularly, the present invention relates to certain tables that may be mounted to a vehicle hitch receiver. According to certain preferred embodiments of the invention, vehicle hitch receiver mountable tables are provide that comprise (i) a hitch end for mounting the table to the hitch receiver, (ii) a frame section comprising a bottom end pivotally attached to the hitch end, (iii) a table support structure pivotally attached to a top end of the frame section, and (iv) a table top attached to the table support structure.

### CROSS-REFERENCE TO RELATED APPLICATIONS

This application claims priority to and incorporates by reference U.S. provisional patent application Ser. No. 60/795,380, filed Apr. 27, 2006.

### FIELD OF THE INVENTION

The present invention relates to vehicle hitch receiver accessories. More particularly, the present invention relates to certain tables that may be mounted to a vehicle hitch receiver.

### BACKGROUND OF THE INVENTION

The present invention relates to an apparatus which serves as a portable table that easily mounts to vehicle hitch receivers. Vehicle hitch mounted products, or accessories, have become popular due to an American automotive industry standardization of tow hitch ports integral to the rear frame of the vehicle. Most domestically produced utilitarian vehicles (i.e. SUV's, pick-ups, vans) feature a square, tubular port, or hitch receiver, intended for the removable attachment of hitches for towing purposes. Common to the market are numerous vehicle-mounted products which removably attach to the vehicle via the hitch receiver. These products include, but are not limited to, bicycle racks, ski racks, pick-up bed extenders, cargo carriers and tables.

Hitch receiver mounted tables are not new to the marketplace. Several United States patents present various embodiments and adaptations of these tables. U.S. Pat. No. 6,189,458 by Rivera presents a table with provision for mounting an umbrella and barbeque grill. A hitch mounted table with seats and umbrella is described by Anderson in U.S. Pat. No. 5,857,741. A table known in the marketplace is designed to transport on a vehicle in a vertical position pinned in the receiver hitch for transport, but the design does not locate the table close enough to the vehicle. The table assembly sits approximately 20″ from the rear of the vehicle. This is a relatively dangerous and undesirable distance from the rear of the vehicle considering the length and limited vision to the rear of most vehicles with hitch receivers. The top of the known tailgate table is also a single piece which is required to ship to a customer at an oversized category and is therefore expensive to ship. The known tailgate table design does not include a protective cover to keep the top clean while in transit. The table top may be exposed to compounds common to road surfaces such as oil and salt. The known table weighs approximately 50 pounds, which makes it difficult to mount to the hitch receiver. Accordingly, there is a need for a hitch receiver mounted table which mounts close to the vehicle, occupies a small packaged size and is easy to manipulate while mounting to the hitch receiver and during use.

### BRIEF DESCRIPTION OF THE DRAWINGS

FIG. 1 is an exploded right side perspective view of a vehicle hitch receiver and table in the transport position.

FIG. 2 is an assembled view of FIG. 1.

FIG. 3 is a right side perspective view of the table.

FIG. 4 is an exploded right side perspective view of FIG. 3.

FIG. 5 is a detailed view of the table support structure.

FIG. 6 is a right side perspective view of a vehicle hitch receiver and the table in the standing position.

FIG. 7 is a right side perspective view of a vehicle hitch receiver and the table in the sitting position.

FIG. 8 is an exploded detailed view of the bottom hinge while the table is in the standing position.

FIG. 9 is a detailed view of the bottom hinge while the table is in the sitting position.

FIG. 10 is an exploded detailed view of the top hinge while the table is in the standing position.

FIG. 11 is a detailed view of the top hinge while the table is in the sitting position.

FIG. 12 is an exploded right side perspective of the table and cover.

FIG. 13 is an assembled view of FIG. 12.

### DESCRIPTION OF THE PREFERRED EMBODIMENT

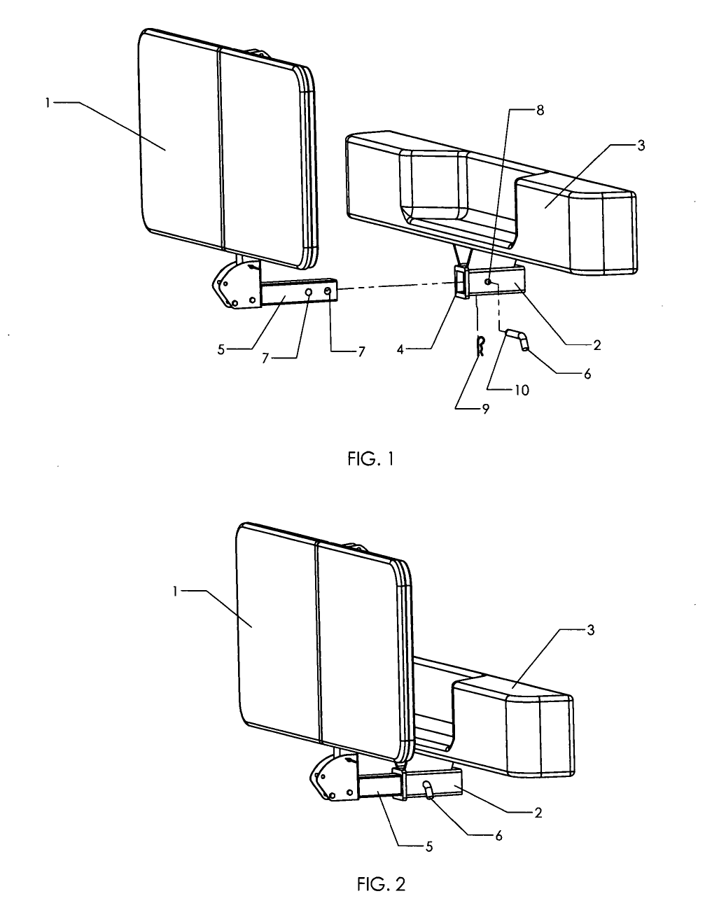

A transportable table of the present invention removably attaches to the hitch receiver of a vehicle. An embodiment of the present invention, generally indicated as the table 1, as shown in FIGS. 1-2, is removably attachable to the hitch receiver 2, which is generally integral to the vehicle frame and protrudes below the rear bumper 3. The hitch receiver 2 is of a square, tubular shape with a nominally sized square opening 4. The table 1, as do all hitch receiver-mounted accessories, has a square, tubular hitch end 5 that telescopically mates with the hitch receiver 2. A hitch pin 6, fabricated of steel round stock, is used to attach the table 1 to the hitch receiver 2. A nominally sized round through hole 7 perpendicular to the side surface of the hitch end 5, is aligned with a similarly sized round through hole 8 in the side surface of the hitch receiver 2. The hitch pin 6 is inserted through both holes 7, 8. The hitch pin 6 is transversely secured by a bridge pin 9 inserted into a through hole 10 perpendicular to the outer surface of the hitch pin 6. FIG. 2 illustrates the orientation of the table I in the transport position.

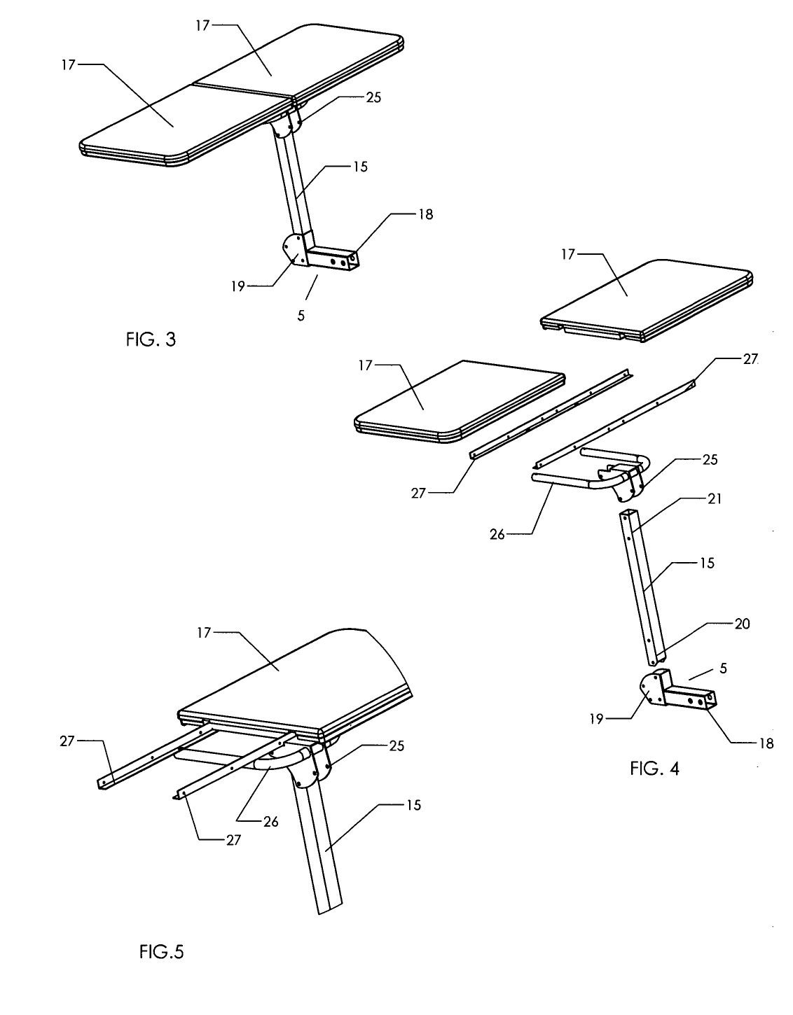

As shown in FIGS. 3-5, one embodiment of the table 1 includes four subsystems, namely, a hitch end 5, a frame section 15; a table support structure generally indicated and a table top 17. The hitch end 5 consists of a hitch tube 18 that is rigidly connected to a bottom hinge 19. The bottom hinge 19 has a u-shaped cross-section creating an opening nominally sized to accept the outer perimeter of the frame section 15. The bottom hinge 19 is pivotally connected to the frame section 15 lower end indicated 20. The table support structure pivotally attaches to the frame section 15 top end indicated 21. A top hinge 25, u-tube 26 and table angles 27 comprise the table support structure. The u-tube 26 is rigidly connected to the top hinge 25 with the table angles 27 rigidly attached to the u-tube 26 by machine screws. The u-tube 26 provides support for the table angles 27, which in turn support the table top sections 17. The table top sections 17 are molded as identical pieces.

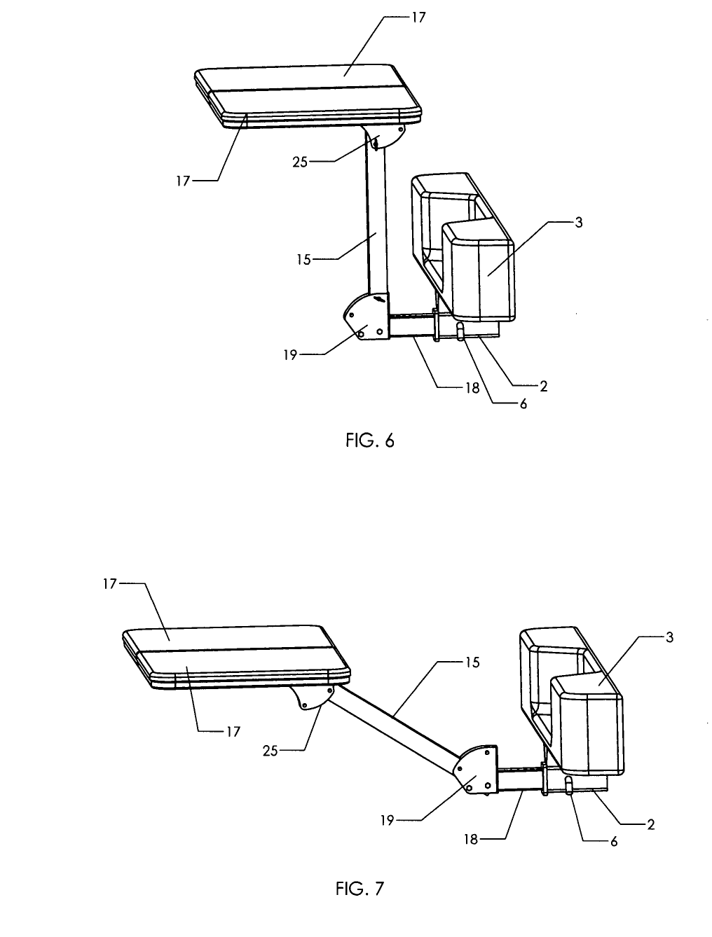

The present embodiment of the table 1 features two different positions during use: a standing, or bar, height and a sitting height. The standing height positions the vertical distance from the top surface of the table tops 17 to the ground at approximately 42″ (see FIG. 6), while the sitting height positions the vertical distance from the top surface of the table tops 17 to the ground at approximately 30″ (see FIG. 7). The vertical distances will vary depending on height above ground of the receiver hitch 2 for each model of vehicle. Note the angular positions of the frame section 15 to create the different height positions for the table tops 17.

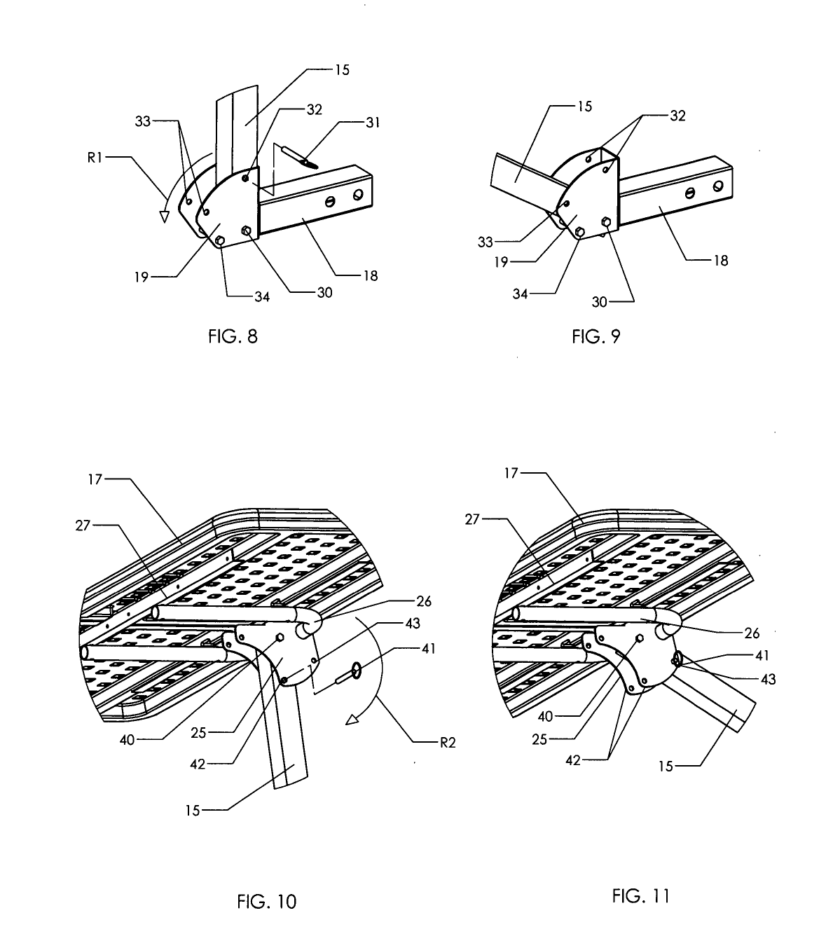

FIGS. 8 and 9 illustrate the method of rotating and locking the frame section 15 in place relative to the bottom hinge 19. The frame section 15 is pivotally retained to the bottom hinge 19 by a hex bolt 30 passing longitudinally through axially aligned mating holes in the frame section 15 and the bottom hinge 19. To move the frame section 15 from the standing position (see FIG. 8) to the sitting position (see FIG. 9) a locking pin 31 must be removed from the axially aligned holes indicated 32 in the frame section 15 and bottom hinge 19. The frame section 15 is rotated in the direction indicated R1 about the hex bolt 30 until the through holes in the frame section 15 and bottom hinge 19 are axially aligned at the location indicated 33. The locking pin 31 is then inserted into the axially aligned holes at location 33 to prevent further rotation of the frame section 15 relative to the bottom hinge 19. Moving the frame section from the sitting position to the standing position is the opposite of the procedure described above. A hex bolt 34 passing longitudinally through the bottom hinge 19 acts as a rotation limiting device to keep the frame section 15 from rotating too far in the direction indicated R1 and possibly causing the table 1 to strike the ground.

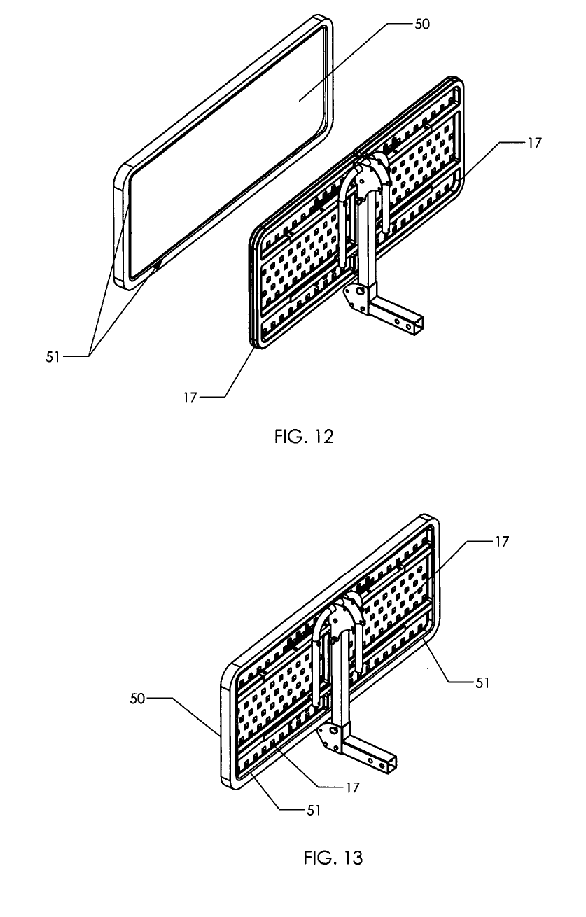

FIGS. 10 and 11 illustrate the method of rotating and locking the frame section 15 in place relative to the top hinge 25 and, therefore, the u-tube 26, table angles 27 and table tops 17. The frame section 15 is pivotally retained to the top hinge 25 by a hex bolt 40 passing longitudinally through axially aligned mating holes in the frame section 15 and the top hinge 25. To move the top hinge 25 from the standing position (see FIG. 10) to the sitting position (see FIG. 11) a locking pin 41 must be removed from the axially aligned holes indicated 42 in the frame section 15 and top hinge 25. The top hinge 25, and therefore, the u-tube 26, table angles 27 and table tops 17, is rotated in the direction indicated R2 about the hex bolt 40 until the through holes in the frame section 15 and top hinge 25 are axially aligned at the location indicated 43. The locking pin 41 is then inserted into the axially aligned holes at location 43 to prevent further rotation of the top hinge 25 relative to the frame section 15. Moving the top hinge 25 from the sitting position to the standing position is the opposite of the procedure described above.

A table cover 50, fabricated of flexible, weather resistant material may be removably attached to the table (see FIGS. 12-13). The table cover 50 is fabricated to the same nominal dimensions as the table tops 17 as they are assembled to the table 1. The inner perimeter 51 of the table cover will overlap the bottom perimeter of the table sections in the same manner a fitted sheet overlaps the bottom perimeter of a mattress. An elastic cord is sewn into the perimeter of the cover 50 to provide retaining tension around the inner perimeter 51.

What is claimed is:

1. A vehicle hitch receiver mountable table comprising:
a hitch end for mounting the table to the hitch receiver;
a frame section comprising a bottom end pivotally attached to the hitch end;
a table support structure pivotally attached to a top end of the frame section; and
a table top attached to the table support structure.

2. The table of claim 1, wherein the table top comprises multiple identical sections to form a single surface.

3. The table of claim 1, wherein the table top may remain attached to the vehicle hitch receiver during transport.

4. The table of claim 1, wherein the frame section, table support structure and table top are adjustable relative to each other to allow the table top to be fixed in multiple positions.

5. The table of claim 4, wherein the multiple positions include (i) multiple positions in which the table top is held in a substantially horizontal position and (ii) a position in which the table top is held in a substantially vertical position.

6. The table of claim 5, wherein the table top is moved to a position by rotating the hitch end, frame section and table support structure relative to each other.

7. The table of claim 6, wherein a pin is removably retained in mating holes between (i) the frame section and hitch end and (ii) the frame section and table support structure.

8. The table of claim 1, further comprising a weather resistant cover that removably attaches to the table top.

9. The table of claim 1, wherein the hitch end comprises a length of square tubing adapted to mate with the vehicle hitch receiver, wherein the hitch end is rigidly attached to a hinge plate having a generally u-shaped cross-section.

10. The table of claim 9, further comprising a pin that may be inserted into a through hole perpendicular to the central axis of the tubing, wherein the pin is effective to limit the rotation of the frame section.

11. The table of claim 9, wherein the frame section comprises a tube having through holes located in both ends thereof.

12. A vehicle hitch receiver mountable table comprising:
(a) a hitch end for mounting the table to the hitch receiver;
(b) a frame section comprising a bottom end pivotally attached to the hitch end;
(c) a table support structure pivotally attached to a top end of the frame section; and
(d) a table top attached to the table support structure, wherein the frame section, table support structure and table top are adjustable relative to each other to allow the table top to be fixed in multiple positions, wherein said multiple positions comprise (i) positions in which the table top is held in a substantially horizontal position and (ii) positions in which the table top is held in a substantially vertical position.

13. The table of claim 12, wherein the table top is moved to a position by rotating the hitch end, frame section and table support structure relative to each other.

14. The table of claim 13, wherein a pin is removably retained in mating holes between (i) the frame section and hitch end and (ii) the frame section and table support structure.

15. The table of claim 14, further comprising a weather resistant cover that removably attaches to the table top.
